(19) United States
(12) Patent Application Publication
(10) Pub. No.: US 2025/0106060 A1
(43) Pub. Date: Mar. 27, 2025

(54) SYSTEM AND METHOD FOR GENERATION OF A POST-MEETING MESSAGE

(71) Applicant: The Toronto-Dominion Bank, Toronto (CA)

(72) Inventors: Breena Patricia GORMLEY, Toronto (CA); Claire Patricia ORANGE, Toronto (CA)

(21) Appl. No.: 18/473,673

(22) Filed: Sep. 25, 2023

(51) Int. Cl. H04L 12/18

(52) U.S. Cl. CPC H04L 12/1831

(57) ABSTRACT

Computing platforms, methods, and storage media for automatic generation of a post-meeting message are disclosed. Exemplary implementations may: obtain, by an apparatus, meeting-based content associated with a meeting between a client and an advisor; transmit the meeting-based content comprising a meeting transcript to a conversational artificial intelligence tool with a prompt for generation of content for a draft post-meeting message; obtain, by the apparatus and from the conversational AI tool, a processed output of the conversational AI tool; dynamically generate, by the apparatus, the draft post-meting message based on the processed output of the conversational AI tool; and provide the draft post-meeting message to an advisor computing device associated with the advisor for review or modification prior to sending to the client.

### FIELD

The present disclosure relates to content generation, including but not limited to computing platforms, methods, and storage media for generation of a post-meeting message.

### BACKGROUND

Many types of advisors or representatives, including in the professional services space, spend a lot of time preparing for and conducting meetings with clients and prospective clients. Such meetings may cover a wide range of topics, and may require different types of follow-up depending on what was discussed, or the outcome of those discussions.

According to one known approach, an advisor or representative may need to manually determine an appropriate follow-up to a particular client meeting, and then produce and send that follow-up. This can be time consuming and inefficient. In another known approach, the organization for whom the advisor or representative works may generate and send a generic follow-up message. However, such generic follow-up messages are often ignored by clients, and often do not have the intended result of continuing or furthering the client discussion or building the client relationship.

Improvements in approaches for post-meeting interaction management are desirable.

### BRIEF DESCRIPTION OF THE DRAWINGS

Embodiments of the present disclosure will now be described, by way of example only, with reference to the attached Figures.

FIG. 1 illustrates a system configured for automatic generation of a post-meeting message, in accordance with one or more embodiments.

FIG. 2 illustrates another system configured for automatic generation of a post-meeting message, in accordance with one or more embodiments.

FIG. 3 illustrates a method for automatic generation of a post-meeting message, in accordance with one or more embodiments.

### DETAILED DESCRIPTION

Computing platforms, methods, and storage media for automatic generation of a post-meeting message are disclosed. Exemplary implementations may: obtain, by an apparatus, meeting-based content associated with a meeting between a client and an advisor; transmit the meeting-based content comprising a meeting transcript to a conversational artificial intelligence (AI) tool with a prompt for generation of content for a draft post-meeting message; obtain, by the apparatus and from the conversational AI tool, a processed output of the conversational AI tool; dynamically generate, by the apparatus, the draft post-meting message based on the processed output of the conversational AI tool; and provide the draft post-meeting message to an advisor computing device associated with the advisor for review or modification prior to sending to the client.

Embodiments of the present disclosure provide a platform for generating a post-meeting message based on a meeting transcript, for example leveraging a conversational Al tool such as ChatGPT. Generation of the post-meeting message may be performed automatically, after initiation of a first step in process. Generation of the post-meeting message may be performed dynamically, based on the meeting transcript dynamically generated based on the meeting between the client and the advisor. The draft post-meeting message may be dynamically and automatically generated based on the meeting transcript and using content dynamically generated by the conversational AI tool. Dynamic generation of the draft-post meeting message may be performed using content dynamically generated by the conversational AI tool and based on the meeting transcript. Such an approach enables the system to reflect and include advances in the conversational AI tool and updates to the training data of the conversational AI tool, to ensure generation of a relevant draft post-meeting message.

Embodiments of the present disclosure provide a system for analyzing meeting-based content, and generating a post-meeting message, for example based on a meeting transcript. The post-meeting message may be generated by providing the meeting-based content to a generative pre-trained transformer large language model (GPT LLM), such as ChatGPT. The post-meeting message may be provided as a draft message to an advisor, such as a personal banker, enabling the advisor to review and personally send the message, rather than have the message be automatically sent without review.

There is a technical problem of not being able to automatically generate customized or personalized post-meeting messages, for example due to a lack of data about the specific meeting being referenced. Embodiments of the present disclosure solve this technical problem by obtaining meeting-based content, for example based on data stored or obtained via a meeting management interface and/or based on a generated meeting transcript, and using the meeting-based content for automatic generation of the post-meeting message.

One aspect of the present disclosure relates to an apparatus or a computing platform configured for automatic generation of a post-meeting message. The apparatus may include a non-transient computer-readable storage medium having executable instructions embodied thereon. The apparatus may include one or more hardware processors configured to execute the instructions. The processor(s) may execute the instructions to obtain, by the apparatus, meeting-based content associated with a meeting between a client and an advisor. The meeting-based content may include a meeting transcript. The processor(s) may execute the instructions to transmit the meeting-based content including the meeting transcript to a conversational artificial intelligence tool with a prompt for generation of content for a draft post-meeting message. The processor(s) may execute the instructions to obtain, by the apparatus and from the conversational AI tool, a processed output of the conversational AI tool. The processor(s) may execute the instructions to dynamically generate, by the apparatus, the draft post-meting message based on the processed output of the conversational AI tool. The processor(s) may execute the instructions to provide the draft post-meeting message to an advisor computing device associated with the advisor for review or modification prior to sending to the client.

Another aspect of the present disclosure relates to a method for automatic generation of a post-meeting message. The method may include obtaining, by an apparatus, meeting-based content associated with a meeting between a client and an advisor. The meeting-based content may include a meeting transcript. The method may include transmitting the meeting-based content including the meeting transcript to a conversational artificial intelligence tool with a prompt for generation of content for a draft post-meeting message. The method may include obtaining, by the apparatus and from the conversational AI tool, a processed output of the conversational AI tool. The method may include dynamically generating, by the apparatus, the draft post-meting message based on the processed output of the conversational AI tool. The method may include providing the draft post-meeting message to an advisor computing device associated with the advisor for review or modification prior to sending to the client.

Yet another aspect of the present disclosure relates to a non-transient computer-readable storage medium having instructions embodied thereon, the instructions being executable by one or more processors to perform a method for automatic generation of a post-meeting message. The method may include obtaining, by an apparatus, meeting-based content associated with a meeting between a client and an advisor. The meeting-based content may include a meeting transcript. The method may include transmitting the meeting-based content including the meeting transcript to a conversational artificial intelligence tool with a prompt for generation of content for a draft post-meeting message. The method may include obtaining, by the apparatus and from the conversational AI tool, a processed output of the conversational AI tool. The method may include dynamically generating, by the apparatus, the draft post-meting message based on the processed output of the conversational AI tool. The method may include providing the draft post-meeting message to an advisor computing device associated with the advisor for review or modification prior to sending to the client.

A further aspect of the present disclosure relates to a method of automatic generation of a post-meeting message. The method may include: obtaining, by the apparatus, meeting-based content associated with a specific meeting between a client and an advisor, the meeting-based content comprising a meeting transcript; dynamically generating, by the apparatus, a draft post-meting message based on the meeting-based content including the meeting transcript; and providing the draft post-meeting message to an advisor computing device associated with the advisor for review or modification prior to sending to the client. Additional aspects of the present disclosure relate to an apparatus or a computing platform configured to perform the method, and to a non-transient computer-readable storage medium having instructions embodied thereon, the instructions being executable by one or more processors to perform the method.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Embodiments of the present disclosure provide a method/system configured to automatically generate a customized or personalized post-meeting follow-up message in response to completion of a client meeting with an advisor.

Meeting-based content may be obtained or generated before or after the client meeting. For example, a meeting agenda may be stored in a system prior to the meeting occurring, where the system may be associated with an apparatus or device configured to perform a method according to embodiments of the present disclosure. Such meeting-based content, for example including a meeting agenda, may then be used to generate the post-meeting message. Other meeting-based content may include or be based on notes provided by the advisor during or after the meeting, such as may be recorded or stored in a meeting management system. For example, the system may provide the advisor with a plurality of common meeting topics, and the advisor may simply select one or more of the meeting topics as applicable to that meeting. The system may then receive and store the selected meeting topic(s), and optionally associate the topic(s) with specific portions of the meeting or time periods of the meeting.

In an implementation, the meeting-based content may include a meeting transcript. Many online meeting tools, such as Zoom™ and Microsoft™ Teams, are configured to produce or generate a meeting transcript based on analysis and processing of the audio portion of the meeting. Such technology and approaches may easily be used when the client meeting occurs virtually. In other embodiments, speech-to-text or other audio transcription technology may be leveraged to generate a meeting transcript based on audio from an in-person meeting, where the audio may be obtained from or via microphones or speakers in a meeting room. The microphones or speakers may be present in an audio system or conferencing system in the meeting room, or may be brought in to the meeting room for example as part of an advisor computing device such as a laptop, tablet or mobile phone.

The system may analyze the meeting transcript to identify key topics discussed during the meeting, to store the key topics and associate them with the meeting, and optionally associate the topics with certain times or time periods of the meeting. For example, based on meeting recording data contained in or associated with the meeting transcript, each key topic may be associated with one or more times or time periods in the meeting during which the key topic is identified or determined to have been discussed. The identified key topics may be compared to an organization's stored set of meeting topics, so that the identified meeting topics are relevant to the topics that are most commonly discussed, and most important to, the organization.

In an example embodiment, the system is configured to automatically generate a post-meeting message based on a meeting transcript, for example leveraging a conversational AI tool such as a GPT LLM like ChatGPT. The system may analyze meeting-based content, and generate a post-meeting message, for example based on a meeting transcript and based on a prompt for generation of content for a draft post-meeting message.

The post-meeting message may be provided as a draft message to an advisor or agent such as a personal banker. The draft message may be generated in a format that is compatible with any number of messaging platforms, including: standard email, proprietary CRM tools that may also be configured to send/receive emails, and other messaging platforms such as Messenger and WhatsApp™.

The advisor may then review the automatically-generated draft message, and personally send the message, rather than have the message be automatically sent without review, or without human review. This provides flexibility for the advisor to modify or remove any of the automatically-generated content, or to add a personal touch or further details based on their own experience during or after the meeting. For example, an advisor may modify or remove a portion of the draft message that was generated based on a mis-transcription of a certain expression or phrase, or based on a mis-interpretation by the system of content of the meeting transcript.

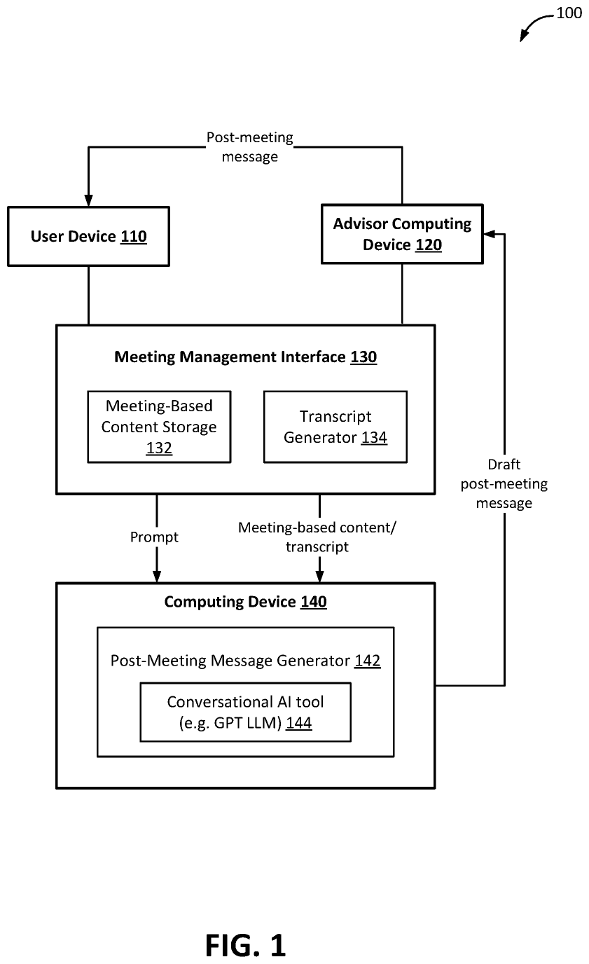

FIG. 1 illustrates a system 100 configured for automatic generation of a post-meeting message, in accordance with one or more embodiments. A user device 110 and an advisor computing device 120 may be in communication with a meeting management interface 130, and may communicate with each other via the meeting management interface 130. The meeting management interface 130 may comprise or be configured to obtain meeting-based content, for example via meeting-based content storage 132.

In an embodiment, the meeting management interface 130 may comprise an online meeting platform, such as Zoom™, Webex™ or Microsoft™ Teams. The meeting management interface 130 may comprise or be in communication with a transcript generator 134 configured to generate a transcript of a meeting between a user and an advisor. In the case of an online meeting platform, the meeting management interface 130 may already comprise a transcript generator 134.

In another embodiment, the meeting management interface 130 may comprise an audio-visual system, for example provided in a conference room or meeting room set up for in-person meetings. In the case where the meeting management interface comprises an audio-visual system, one or more microphones from the audio-visual system may be used to obtain audio content from the meeting and to provide the audio content to a transcript generator 134, which is in communication with the meeting management interface 130.

A computing device 140 may be configured to receive the meeting based-content and/or the meeting transcript from the meeting management interface 130. The computing device 142 may comprise a post-meeting message generator 142, configured to generate a draft post-meeting message, based on the meeting transcript and optionally on other meeting-based content, such as stored meeting agenda items or stored meeting follow-up items. The post-meeting message generator 142 may comprise a conversational AI tool such as a GPT LLM 144, for example ChatGPT. The GPT LLM 144 may analyze the meeting based-content and/or the meeting transcript from the meeting management interface 130 and be configured to generate the draft post-meeting message.

The meeting management interface 130 may be configured to transmit the meeting-based content comprising the meeting transcript to the computing device 140 comprising a conversational artificial intelligence (AI) tool with a prompt for generation of content for the draft post-meeting message.

The post-meeting message may be generated by providing the prompt and the meeting-based content to the computing device 140, which may comprise a post-meeting message generator 142 configured to dynamically generate an output. The prompt may be sent by or generated by an apparatus or system in communication with the conversational Al tool. For example, the prompt may be sent via or generated by the meeting management interface 130. The prompt may comprise or include post-meeting message data associated with desired characteristics of the post-meeting message, which in example embodiments may obtained from the user device 110 or the advisor computing device 120. The post-meeting message data may be associated with or define desired characteristics of a dynamically generated or automatically generated post-meeting message.

The prompt may include post-meeting message data or instructions associated with a message type associated with the draft post-meeting message to be generated. The message type may comprise, for example: a message following a first ever meeting with a client; a message following a first meeting with a client discussing a given subject; or a message following a subsequent meeting with a client during which one or more decisions or action items are expected.

The prompt may include post-meeting message data or instructions associated with a message format of the draft post-meeting message to be generated. The message format may comprise, for example: a text message or short messaging system (SMS) message; an email message in a standalone email application or client, such as an email app; an email message in an online or web-based email client; a messaging platform format such as Facebook™ Messenger or WhatsApp™; or content or text to be used in a proprietary CRM tool that may also be configured to send/receive emails.

The prompt may include post-meeting message data or instructions associated with a message style associated with the draft post-meeting message to be generated. The message style may comprise, define or be associated with an intended tone of the message. The message style may comprise, for example: a conversational style; a formal style; a legal agreement style; an older demographic style; a younger demographic style.

The computing device 140 may be configured to provide the draft post-meeting message to the advisor computing device 120, either directly or via the meeting management interface 130. The meeting management interface 130 may be configured to obtain, from the conversational AI tool, a processed output of the conversational AI tool. The meeting management interface 130 may be configured to generate the draft post-meting message based on the processed output of the conversational AI tool.

At the advisor computing device, an advisor may review the draft post-meeting message and optionally modify the message. The advisor computing device 120 may be configured to send the post-meeting message to the user device 110 in response to receipt of an approval of the draft post-meeting message, possibly including modifications.

The computing device 140 may optionally be configured to cooperate with the conversational AI tool such as the GPT LLLM 144 to provide a follow-up experience for the client. For example, a client may access their messaging platform, possibly the same platform on which they received the post-meeting message, and engage with an advisor ChatGPT plugin to continue the conversation and get automated advice. This may be in addition to, or instead of, continuing advice with a live advisor.

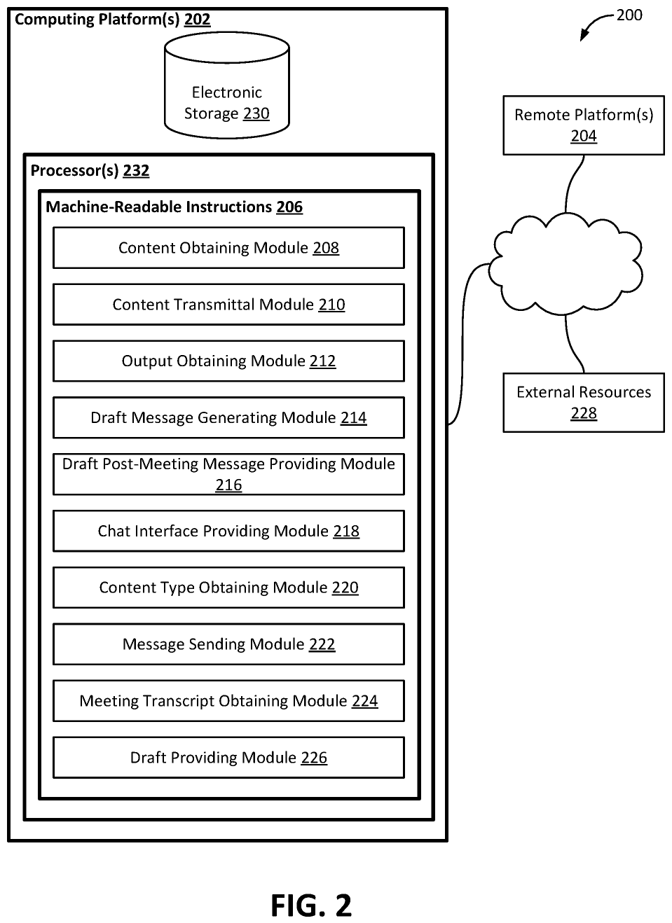

FIG. 2 illustrates a system 200 configured for automatic generation of a post-meeting message, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of content obtaining module 208, content transmittal module 210, output obtaining module 212, draft message generating module 214, draft post-meeting message providing module 216, chat interface providing module 218, content type obtaining module 220, message sending module 222, meeting transcript obtaining module 224, draft providing module 226, and/or other instruction modules.

Content obtaining module 208 may be configured to obtain, by an apparatus, meeting-based content associated with a meeting between a client and an advisor. The meeting-based content may include a meeting transcript.

Content transmittal module 210 may be configured to transmit the meeting-based content including the meeting transcript to a conversational artificial intelligence tool with a prompt for generation of content for a draft post-meeting message. The output of the conversational AI tool may include content generated based on the meeting transcript. Output obtaining module 212 may be configured to obtain, by the apparatus and from the conversational AI tool, a processed output of the conversational AI tool.

Draft message generating module 214 may be configured to dynamically generate, by the apparatus, the draft post-meting message based on the processed output of the conversational AI tool. Draft message generating module 214 may be configured to dynamically generate, by the apparatus, the draft post-meting message based on the meeting-based content including the meeting transcript and based on a first and/or second type of meeting-based content, for example based on stored meeting agenda items or meeting notes.

Draft post-meeting message providing module 216 may be configured to provide the draft post-meeting message to an advisor computing device associated with the advisor for review or modification prior to sending to the client.

Chat interface providing module 218 may be configured to provide, by the apparatus, a chat interface enabling the client to interact with the conversational AI tool after generation of the post-meeting message. Chat interface providing module 218 may be configured to provide, by the apparatus, the chat interface enabling the client to interact with the conversational AI tool on a platform for which the draft post-meeting message was provided without revealing whether the interaction is with the conversational AI tool or with the advisor.

Content type obtaining module 220 may be configured to obtain, by the apparatus, a first type of meeting-based content based on meeting agenda items stored prior to the specific meeting. Content type obtaining module 220 may be configured to obtain, by the apparatus, a second type of meeting-based content based on notes provided by the advisor during or after the specific meeting.

Message sending module 222 may be configured to send, by the apparatus and in response to an approval indicator received from the advisor computing device, a finalized post-meeting message to a client device. The finalized post-meeting message may be sent to the client device by or via the advisor computing device.

Meeting transcript obtaining module 224 may be configured to obtain, by the apparatus, the meeting transcript from a meeting management interface configured to obtain the meeting-based content. The meeting management interface may include a transcript generator. Meeting transcript obtaining module 224 may be configured to obtain, by the apparatus, the meeting transcript based on a transcript generated by an online meeting platform, a transcript generated from an audio portion of a phone call, or a transcript generated from an audio recording of an in-person meeting via a sound system in a meeting room.

Draft providing module 226 may be configured to provide the draft post-meeting message to the advisor computing device or to a message management interface in a format selected from the group consisting of a draft email pre-addressed to an email address associated with the client, a draft online communications application message pre-addressed to an application username associated with the client, and a draft text message pre-composed to a mobile phone number associated with the client.

In some implementations, the conversational AI tool may include a generative pretrained transformer large language model.

In some embodiments, computing platform(s) 202, remote platform(s) 204, and/or external resources 228 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 228 may be operatively linked via some other communication media.

A given remote platform 204 may include one or more processors configured to execute computer program modules. The computer program modules may be configured to enable an expert or user associated with the given remote platform 204 to interface with system 200 and/or external resources 228, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 228 may include sources of information outside of system 200, external entities participating with system 200, and/or other resources. In some embodiments, some or all of the functionality attributed herein to external resources 228 may be provided by resources included in system 200.

Computing platform(s) 202 may include electronic storage 230, one or more processors 232, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 230 may comprise non-transitory storage media that electronically stores information. The electronic storage media of electronic storage 230 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 230 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 230 may include one or more virtual storage resources (e.g., cloud storage, a virtual private network, and/or other virtual storage resources). Electronic storage 230 may store software algorithms, information determined by processor(s) 232, information received from computing platform(s) 202, information received from remote platform(s) 204, and/or other information that enables computing platform(s) 202 to function as described herein.

Processor(s) 232 may be configured to provide information processing capabilities in computing platform(s) 202. As such, processor(s) 232 may include one or more of a digital processor, an analog processor, a digital circuit designed to process information, an analog circuit designed to process information, a state machine, and/or other mechanisms for electronically processing information. Although processor(s) 232 is shown in FIG. 2 as a single entity, this is for illustrative purposes only. In some embodiments, processor(s) 232 may include a plurality of processing units. These processing units may be physically located within the same device, or processor(s) 232 may represent processing functionality of a plurality of devices operating in coordination. Processor(s) 232 may be configured to execute modules 208, 210, 212, 214, 216, 218, 220, 222, 224, and/or 226, and/or other modules. Processor(s) 232 may be configured to execute modules 208, 210, 212, 214, 216, 218, 220, 222, 224, and/or 226, and/or other modules by software; hardware; firmware; some combination of software, hardware, and/or firmware; and/or other mechanisms for configuring processing capabilities on processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, and/or 226 are illustrated in FIG. 2 as being implemented within a single processing unit, in embodiments in which processor(s) 232 includes multiple processing units, one or more of modules 208, 210, 212, 214, 216, 218, 220, 222, 224, and/or 226 may be implemented remotely from the other modules. The description of the functionality provided by the different modules 208, 210, 212, 214, 216, 218, 220, 222, 224, and/or 226 described below is for illustrative purposes, and is not intended to be limiting, as any of modules 208, 210, 212, 214, 216, 218, 220, 222, 224, and/or 226 may provide more or less functionality than is described. For example, one or more of modules 208, 210, 212, 214, 216, 218, 220, 222, 224, and/or 226 may be eliminated, and some or all of its functionality may be provided by other ones of modules 208, 210, 212, 214, 216, 218, 220, 222, 224, and/or 226. As another example, processor(s) 232 may be configured to execute one or more additional modules that may perform some or all of the functionality attributed below to one of modules 208, 210, 212, 214, 216, 218, 220, 222, 224, and/or 226.

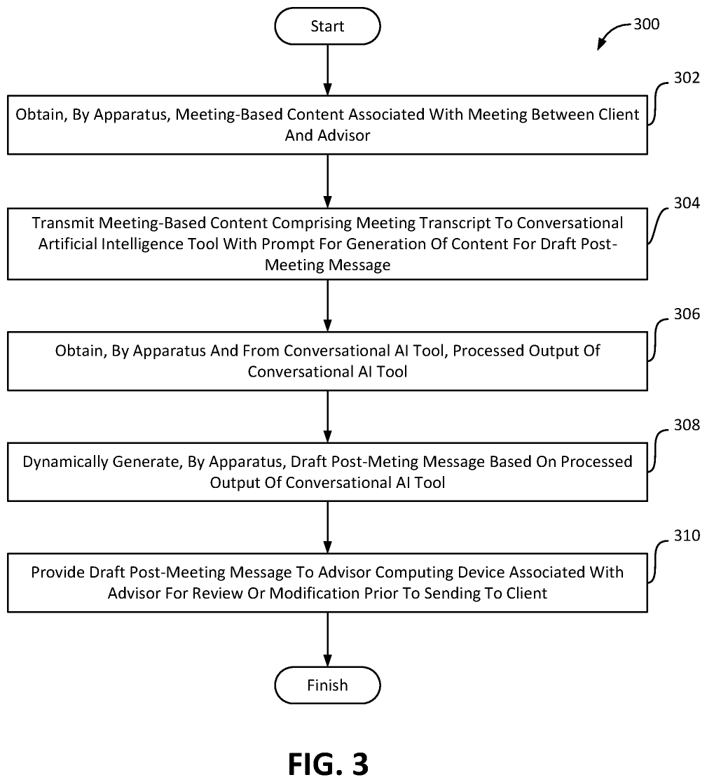

FIG. 3 illustrates a method 300 for automatic generation of a post-meeting message, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, by an apparatus, meeting-based content associated with a meeting between a client and an advisor. The meeting-based content may include a meeting transcript. Operation 302 may be performed by one or more hardware processors configured by machine-readable instructions including a module that is the same as or similar to content obtaining module 208, in accordance with one or more embodiments.

An operation 304 may include transmitting the meeting-based content including the meeting transcript to a conversational artificial intelligence tool with a prompt for generation of content for a draft post-meeting message. Operation 304 may be performed by one or more hardware processors configured by machine-readable instructions including a module that is the same as or similar to content transmittal module 210, in accordance with one or more embodiments.

An operation 306 may include obtaining, by the apparatus and from the conversational AI tool, a processed output of the conversational AI tool. Operation 306 may be performed by one or more hardware processors configured by machine-readable instructions including a module that is the same as or similar to output obtaining module 212, in accordance with one or more embodiments.

An operation 308 may include dynamically generating, by the apparatus, the draft post-meting message based on the processed output of the conversational AI tool. Operation 308 may be performed by one or more hardware processors configured by machine-readable instructions including a module that is the same as or similar to draft message generating module 214, in accordance with one or more embodiments.

An operation 310 may include providing the draft post-meeting message to an advisor computing device associated with the advisor for review or modification prior to sending to the client. Operation 310 may be performed by one or more hardware processors configured by machine-readable instructions including a module that is the same as or similar to draft post-meeting message providing module 216, in accordance with one or more embodiments.

There is a technical problem of not being able to automatically generate customized or personalized post-meeting messages, for example due to a lack of data about the specific meeting being referenced. Embodiments of the present disclosure solve this technical problem by obtaining and/or generating meeting-based content, for example based on data stored or obtained via a meeting management interface and/or based on a generated meeting transcript. The meeting-based content comprising the meeting transcript may be transmitted to a computing device comprising or associated with a conversational Al tool with a prompt for generation of content for the draft post-meeting message.

The post-meeting message may be generated by providing the prompt and the meeting-based content to the computing device, which may comprise a post-meeting message generator configured to dynamically generate an output. For example, the prompt may be sent based on post-meeting message data obtained from the user device or the advisor computing device. The post-meeting message data may be associated with or define desired characteristics of a dynamically generated or automatically generated post-meeting message. For example, the prompt may include instructions associated with one or more of: a message type associated with the draft post-meeting message to be generated; a message format of the draft post-meeting message to be generated; and a message style of the draft post-meeting message to be generated, for example including an intended tone of the message. Providing both the meeting based content including the meeting transcript and the prompt for generation of the draft post-meeting message provides a solution to the technical problem of generating a customized or personalized post-meeting message, by not only providing data about the specific meeting being referenced but also by providing data about or associated with the draft post-meeting message to be generated.

Embodiments of the present disclosure, while solving a problem of generating a customized or personalized post-meeting message, improve functioning of a processor executing or associated with one or more of the advisor computing device and a computing device generating the draft post-meeting message. Including both the prompt with data associated with the draft post-meeting message to be generated and the meeting content including data about the specific meeting referenced reduces the processor load and cost, and reduces the memory required, compared to having to try to generate a suitable post-meeting message in the absence of one or both of the meeting content and the prompt. In addition to the increased reliability and accuracy of the draft post-meeting message, the draft post-meeting message is dynamically and/or automatically generated, which provides a technical improvement over an advisor having to manually create and generate the draft post-meeting message.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for automatic generation of a post-meeting message. The system may include one or more hardware processors configured by machine-readable instructions. The processor(s) may be configured to obtain, by an apparatus, meeting-based content associated with a meeting between a client and an advisor. The meeting-based content may include a meeting transcript. The processor(s) may be configured to transmit the meeting-based content including the meeting transcript to a conversational artificial intelligence tool with a prompt for generation of content for a draft post-meeting message. The processor(s) may be configured to obtain, by the apparatus and from the conversational AI tool, a processed output of the conversational AI tool. The processor(s) may be configured to dynamically generate, by the apparatus, the draft post-meting message based on the processed output of the conversational AI tool. The processor(s) may be configured to provide the draft post-meeting message to an advisor computing device associated with the advisor for review or modification prior to sending to the client.

In some implementations of the system, the output of the conversational AI tool may include content generated based on the meeting transcript.

In some implementations of the system, the conversational AI tool may include a generative pretrained transformer large language model.

In some implementations of the system, the processor(s) may be configured to transmit, to the conversational AI tool, the prompt including post-meeting message data associated with desired characteristics of the post-meeting message.

In some implementations of the system, the processor(s) may be configured to transmit the prompt including the post-meeting message data associated with one or more of: a message type associated with the draft post-meeting message to be generated; a message format of the draft post-meeting message to be generated; and a message style of the draft post-meeting message to be generated, for example including an intended tone of the message.

In some implementations of the system, the processor(s) may be configured to provide, by the apparatus, a chat interface enabling the client to interact with the conversational AI tool after generation of the post-meeting message.

In some implementations of the system, the processor(s) may be configured to provide, by the apparatus, the chat interface enabling the client to interact with the conversational AI tool on a platform for which the draft post-meeting message was provided without revealing whether the interaction is with the conversational AI tool or with the advisor.

In some implementations of the system, the processor(s) may be configured to obtain, by the apparatus, a first type of meeting-based content based on meeting agenda items stored prior to the specific meeting. In some implementations of the system, the processor(s) may be configured to obtain, by the apparatus, a second type of meeting-based content based on notes provided by the advisor during or after the specific meeting.

In some implementations of the system, the processor(s) may be configured to dynamically generate, by the apparatus, the draft post-meting message based on the meeting-based content including the meeting transcript and based on the first and/or second type of meeting-based content.

In some implementations of the system, the processor(s) may be configured to send, by the apparatus and in response to an approval indicator received from the advisor computing device, a finalized post-meeting message to a client device.

In some implementations of the system, the processor(s) may be configured to obtain, by the apparatus, the meeting transcript from a meeting management interface configured to obtain the meeting-based content. In some implementations of the system, the meeting management interface may include a transcript generator.

In some implementations of the system, the processor(s) may be configured to obtain, by the apparatus, the meeting transcript based on a transcript generated by an online meeting platform, a transcript generated from an audio portion of a phone call, or a transcript generated from an audio recording of an in-person meeting via a sound system in a meeting room.

In some implementations of the system, the processor(s) may be configured to provide the draft post-meeting message to the advisor computing device in a format selected from the group consisting of a draft email pre-addressed to an email address associated with the client, a draft online communications application message pre-addressed to an application username associated with the client, and a draft text message pre-composed to a mobile phone number associated with the client.

Another aspect of the present disclosure relates to a method for automatic generation of a post-meeting message. The method may include obtaining, by an apparatus, meeting-based content associated with a meeting between a client and an advisor. The meeting-based content may include a meeting transcript. The method may include transmitting the meeting-based content including the meeting transcript to a conversational artificial intelligence tool with a prompt for generation of content for a draft post-meeting message. The method may include obtaining, by the apparatus and from the conversational AI tool, a processed output of the conversational AI tool. The method may include dynamically generating, by the apparatus, the draft post-meting message based on the processed output of the conversational AI tool. The method may include providing the draft post-meeting message to an advisor computing device associated with the advisor for review or modification prior to sending to the client.

In some implementations of the method, the output of the conversational AI tool may include content generated based on the meeting transcript.

In some implementations of the method, the conversational AI tool may include a generative pretrained transformer large language model.

In some implementations of the method, it may include transmitting, to the conversational AI tool, the prompt including post-meeting message data associated with desired characteristics of the post-meeting message.

In some implementations of the method, it may include transmitting the prompt including the post-meeting message data associated with one or more of: a message type associated with the draft post-meeting message to be generated; a message format of the draft post-meeting message to be generated; and a message style of the draft post-meeting message to be generated, for example including an intended tone of the message.

In some implementations of the method, it may include providing, by the apparatus, a chat interface enabling the client to interact with the conversational AI tool after generation of the post-meeting message.

In some implementations of the method, it may include providing, by the apparatus, the chat interface enabling the client to interact with the conversational AI tool on a platform for which the draft post-meeting message was provided without revealing whether the interaction is with the conversational AI tool or with the advisor.

In some implementations of the method, it may include obtaining, by the apparatus, a first type of meeting-based content based on meeting agenda items stored prior to the specific meeting. In some implementations of the method, it may include obtaining, by the apparatus, a second type of meeting-based content based on notes provided by the advisor during or after the specific meeting.

In some implementations of the method, it may include dynamically generating, by the apparatus, the draft post-meting message based on the meeting-based content including the meeting transcript and based on the first and/or second type of meeting-based content.

In some implementations of the method, it may include sending, by the apparatus and in response to an approval indicator received from the advisor computing device, a finalized post-meeting message to a client device.

In some implementations of the method, it may include obtaining, by the apparatus, the meeting transcript from a meeting management interface configured to obtain the meeting-based content. In some implementations of the method, the meeting management interface may include a transcript generator.

In some implementations of the method, it may include obtaining, by the apparatus, the meeting transcript based on a transcript generated by an online meeting platform, a transcript generated from an audio portion of a phone call, or a transcript generated from an audio recording of an in-person meeting via a sound system in a meeting room.

In some implementations of the method, it may include providing the draft post-meeting message to the advisor computing device in a format selected from the group consisting of a draft email pre-addressed to an email address associated with the client, a draft online communications application message pre-addressed to an application username associated with the client, and a draft text message pre-composed to a mobile phone number associated with the client.

Yet another aspect of the present disclosure relates to a non-transient computer-readable storage medium having instructions embodied thereon, the instructions being executable by one or more processors to perform a method for automatic generation of a post-meeting message. The method may include obtaining, by an apparatus, meeting-based content associated with a meeting between a client and an advisor. The meeting-based content may include a meeting transcript. The method may include transmitting the meeting-based content including the meeting transcript to a conversational artificial intelligence tool with a prompt for generation of content for a draft post-meeting message. The method may include obtaining, by the apparatus and from the conversational AI tool, a processed output of the conversational AI tool. The method may include dynamically generating, by the apparatus, the draft post-meting message based on the processed output of the conversational AI tool. The method may include providing the draft post-meeting message to an advisor computing device associated with the advisor for review or modification prior to sending to the client.

In some implementations of the computer-readable storage medium, the output of the conversational AI tool may include content generated based on the meeting transcript.

In some implementations of the computer-readable storage medium, the conversational AI tool may include a generative pretrained transformer large language model.

In some implementations of the computer-readable storage medium, the method may include transmitting, to the conversational AI tool, the prompt including post-meeting message data associated with desired characteristics of the post-meeting message.

In some implementations of the computer-readable storage medium, the method may include transmitting the prompt including the post-meeting message data associated with one or more of: a message type associated with the draft post-meeting message to be generated; a message format of the draft post-meeting message to be generated; and a message style of the draft post-meeting message to be generated, for example including an intended tone of the message.

In some implementations of the computer-readable storage medium, the method may include providing, by the apparatus, a chat interface enabling the client to interact with the conversational AI tool after generation of the post-meeting message.

In some implementations of the computer-readable storage medium, the method may include providing, by the apparatus, the chat interface enabling the client to interact with the conversational AI tool on a platform for which the draft post-meeting message was provided without revealing whether the interaction is with the conversational AI tool or with the advisor.

In some implementations of the computer-readable storage medium, the method may include obtaining, by the apparatus, a first type of meeting-based content based on meeting agenda items stored prior to the specific meeting. In some implementations of the computer-readable storage medium, the method may include obtaining, by the apparatus, a second type of meeting-based content based on notes provided by the advisor during or after the specific meeting.

In some implementations of the computer-readable storage medium, the method may include dynamically generating, by the apparatus, the draft post-meting message based on the meeting-based content including the meeting transcript and based on the first and/or second type of meeting-based content.

In some implementations of the computer-readable storage medium, the method may include sending, by the apparatus and in response to an approval indicator received from the advisor computing device, a finalized post-meeting message to a client device.

In some implementations of the computer-readable storage medium, the method may include obtaining, by the apparatus, the meeting transcript from a meeting management interface configured to obtain the meeting-based content. In some implementations of the computer-readable storage medium, the meeting management interface may include a transcript generator.

In some implementations of the computer-readable storage medium, the method may include obtaining, by the apparatus, the meeting transcript based on a transcript generated by an online meeting platform, a transcript generated from an audio portion of a phone call, or a transcript generated from an audio recording of an in-person meeting via a sound system in a meeting room.

In some implementations of the computer-readable storage medium, the method may include providing the draft post-meeting message to the advisor computing device in a format selected from the group consisting of a draft email pre-addressed to an email address associated with the client, a draft online communications application message pre-addressed to an application username associated with the client, and a draft text message pre-composed to a mobile phone number associated with the client.

Still another aspect of the present disclosure relates to a system configured for automatic generation of a post-meeting message. The system may include means for obtaining, by an apparatus, meeting-based content associated with a meeting between a client and an advisor. The meeting-based content may include a meeting transcript. The system may include means for transmitting the meeting-based content including the meeting transcript to a conversational artificial intelligence tool with a prompt for generation of content for a draft post-meeting message. The system may include means for obtaining, by the apparatus and from the conversational AI tool, a processed output of the conversational Al tool. The system may include means for dynamically generating, by the apparatus, the draft post-meting message based on the processed output of the conversational AI tool. The system may include means for providing the draft post-meeting message to an advisor computing device associated with the advisor for review or modification prior to sending to the client.

In some implementations of the system, the output of the conversational AI tool may include content generated based on the meeting transcript.

In some implementations of the system, the conversational AI tool may include a generative pretrained transformer large language model.

In some implementations of the system, the system may include means for providing, by the apparatus, a chat interface enabling the client to interact with the conversational AI tool after generation of the post-meeting message.

In some implementations of the system, the system may include means for providing, by the apparatus, the chat interface enabling the client to interact with the conversational AI tool on a platform for which the draft post-meeting message was provided without revealing whether the interaction is with the conversational AI tool or with the advisor.

In some implementations of the system, the system may include means for obtaining, by the apparatus, a first type of meeting-based content based on meeting agenda items stored prior to the specific meeting. In some implementations of the system, the system may include means for obtaining, by the apparatus, a second type of meeting-based content based on notes provided by the advisor during or after the specific meeting.

In some implementations of the system, the system may include means for dynamically generating, by the apparatus, the draft post-meting message based on the meeting-based content including the meeting transcript and based on the first and/or second type of meeting-based content.

In some implementations of the system, the system may include means for sending, by the apparatus and in response to an approval indicator received from the advisor computing device, a finalized post-meeting message to a client device.

In some implementations of the system, the system may include means for obtaining, by the apparatus, the meeting transcript from a meeting management interface configured to obtain the meeting-based content. In some implementations of the system, the meeting management interface may include a transcript generator.

In some implementations of the system, the system may include means for obtaining, by the apparatus, the meeting transcript based on a transcript generated by an online meeting platform, a transcript generated from an audio portion of a phone call, or a transcript generated from an audio recording of an in-person meeting via a sound system in a meeting room.

In some implementations of the system, the system may include means for providing the draft post-meeting message to the advisor computing device in a format selected from the group consisting of a draft email pre-addressed to an email address associated with the client, a draft online communications application message pre-addressed to an application username associated with the client, and a draft text message pre-composed to a mobile phone number associated with the client.

Even another aspect of the present disclosure relates to a computing platform configured for automatic generation of a post-meeting message. The computing platform may include a non-transient computer-readable storage medium having executable instructions embodied thereon. The computing platform may include one or more hardware processors configured to execute the instructions. The processor(s) may execute the instructions to obtain, by an apparatus, meeting-based content associated with a meeting between a client and an advisor. The meeting-based content may include a meeting transcript. The processor(s) may execute the instructions to transmit the meeting-based content including the meeting transcript to a conversational artificial intelligence tool with a prompt for generation of content for a draft post-meeting message. The processor(s) may execute the instructions to obtain, by the apparatus and from the conversational AI tool, a processed output of the conversational AI tool. The processor(s) may execute the instructions to dynamically generate, by the apparatus, the draft post-meting message based on the processed output of the conversational AI tool. The processor(s) may execute the instructions to provide the draft post-meeting message to an advisor computing device associated with the advisor for review or modification prior to sending to the client.

In some implementations of the computing platform, the output of the conversational AI tool may include content generated based on the meeting transcript.

In some implementations of the computing platform, the conversational AI tool may include a generative pretrained transformer large language model.

In some implementations of the computing platform, the processor(s) may execute the instructions to provide, by the apparatus, a chat interface enabling the client to interact with the conversational AI tool after generation of the post-meeting message.

In some implementations of the computing platform, the processor(s) may execute the instructions to provide, by the apparatus, the chat interface enabling the client to interact with the conversational AI tool on a platform for which the draft post-meeting message was provided without revealing whether the interaction is with the conversational Al tool or with the advisor.

In some implementations of the computing platform, the processor(s) may execute the instructions to obtain, by the apparatus, a first type of meeting-based content based on meeting agenda items stored prior to the specific meeting. In some implementations of the computing platform, the processor(s) may execute the instructions to obtain, by the apparatus, a second type of meeting-based content based on notes provided by the advisor during or after the specific meeting.

In some implementations of the computing platform, the processor(s) may execute the instructions to dynamically generate, by the apparatus, the draft post-meting message based on the meeting-based content including the meeting transcript and based on the first and/or second type of meeting-based content.

In some implementations of the computing platform, the processor(s) may execute the instructions to send, by the apparatus and in response to an approval indicator received from the advisor computing device, a finalized post-meeting message to a client device.

In some implementations of the computing platform, the processor(s) may execute the instructions to obtain, by the apparatus, the meeting transcript from a meeting management interface configured to obtain the meeting-based content. In some implementations of the computing platform, the meeting management interface may include a transcript generator.

In some implementations of the computing platform, the processor(s) may execute the instructions to obtain, by the apparatus, the meeting transcript based on a transcript generated by an online meeting platform, a transcript generated from an audio portion of a phone call, or a transcript generated from an audio recording of an in-person meeting via a sound system in a meeting room.

In some implementations of the computing platform, the processor(s) may execute the instructions to provide the draft post-meeting message to the advisor computing device in a format selected from the group consisting of a draft email pre-addressed to an email address associated with the client, a draft online communications application message pre-addressed to an application username associated with the client, and a draft text message pre-composed to a mobile phone number associated with the client.

1. An apparatus configured for automatic generation of a post-meeting message, the apparatus comprising:
a non-transient computer-readable storage medium having executable instructions embodied thereon; and
one or more hardware processors configured to execute the instructions to:
obtain, by the apparatus, meeting-based content associated with a meeting between a client and an advisor, the meeting-based content comprising a meeting transcript;
transmit the meeting-based content comprising the meeting transcript to a conversational artificial intelligence (AI) tool with a prompt for generation of content for a draft post-meeting message;
obtain, by the apparatus and from the conversational AI tool, a processed output of the conversational AI tool;
dynamically generate, by the apparatus, the draft post-meting message based on the processed output of the conversational AI tool; and
provide the draft post-meeting message to an advisor computing device associated with the advisor for review or modification prior to sending to the client.

2. The apparatus of claim 1, wherein the one or more hardware processors are further configured by the instructions to:
transmit, to the conversational AI tool, the prompt including post-meeting message data associated with desired characteristics of the post-meeting message.

3. The apparatus of claim 1, wherein the one or more hardware processors are further configured by the instructions to:
transmit the prompt including the post-meeting message data associated with one or more of: a message type associated with the draft post-meeting message to be generated; a message format of the draft post-meeting message to be generated; and a message style of the draft post-meeting message to be generated, for example including an intended tone of the message.

4. The apparatus of claim 1, wherein the one or more hardware processors are further configured by the instructions to:
provide, by the apparatus, a chat interface enabling a client device associated with the client to interact with the conversational AI tool after generation of the post-meeting message.

5. The apparatus of claim 4, wherein the one or more hardware processors are further configured by the instructions to:
provide, by the apparatus, the chat interface enabling the client to interact with the conversational AI tool on a platform for which the draft post-meeting message was provided without revealing whether the interaction is with the conversational AI tool or with the advisor.

6. The apparatus of claim 1, wherein the one or more hardware processors are further configured by the instructions to:
obtain, by the apparatus, a first type of meeting-based content based on meeting agenda items stored prior to the specific meeting;
obtain, by the apparatus, a second type of meeting-based content based on notes provided by the advisor during or after the specific meeting.

7. The apparatus of claim 6, wherein the one or more hardware processors are further configured by the instructions to:
dynamically generate, by the apparatus, the draft post-meting message based on the meeting-based content including the meeting transcript and based on the first and/or second type of meeting-based content.

8. The apparatus of claim 1, wherein the one or more hardware processors are further configured by the instructions to:
send, by the apparatus and in response to an approval indicator received from the advisor computing device, a finalized post-meeting message to a client device.

9. The apparatus of claim 1, wherein the one or more hardware processors are further configured by the instructions to:
obtain, by the apparatus, the meeting transcript from a meeting management interface configured to obtain the meeting-based content, the meeting management interface comprising a transcript generator.

10. A method of automatic generation of a post-meeting message, the method comprising:
obtaining, by an apparatus, meeting-based content associated with a meeting between a client and an advisor, the meeting-based content comprising a meeting transcript;
transmitting the meeting-based content comprising the meeting transcript to a conversational artificial intelligence (AI) tool with a prompt for generation of content for a draft post-meeting message;
obtaining, by the apparatus and from the conversational AI tool, a processed output of the conversational AI tool; and
dynamically generating, by the apparatus, the draft post-meting message based on the processed output of the conversational AI tool; and
providing the draft post-meeting message to an advisor computing device associated with the advisor for review or modification prior to sending to the client.

11. The method of claim 10, further comprising:
transmitting, to the conversational AI tool, the prompt including post-meeting message data associated with desired characteristics of the post-meeting message.

12. The method of claim 10, further comprising:
transmitting the prompt including the post-meeting message data associated with one or more of: a message type associated with the draft post-meeting message to be generated; a message format of the draft post-meeting message to be generated; and a message style of the draft post-meeting message to be generated, for example including an intended tone of the message.

13. The method of claim 10, further comprising:
providing, by the apparatus, a chat interface enabling the client to interact with the conversational AI tool after generation of the post-meeting message.

14. The method of claim 13, further comprising:
providing, by the apparatus, the chat interface enabling a client device associated with the client to interact with the conversational AI tool on a platform for which the draft post-meeting message was provided without revealing whether the interaction is with the conversational AI tool or with the advisor.

15. The method of claim 10, further comprising:
obtaining, by the apparatus, a first type of meeting-based content based on meeting agenda items stored prior to the specific meeting; and
obtaining, by the apparatus, a second type of meeting-based content based on notes provided by the advisor during or after the specific meeting.

16. The method of claim 13, further comprising:
dynamically generating, by the apparatus, the draft post-meting message based on the meeting-based content including the meeting transcript and based on the first and/or second type of meeting-based content.

17. The method of claim 10, further comprising:
sending, by the apparatus and in response to an approval indicator received from the advisor computing device, a finalized post-meeting message to a client device.

18. The method of claim 10, further comprising:
obtaining, by the apparatus, the meeting transcript from a meeting management interface configured to obtain the meeting-based content, the meeting management interface comprising a transcript generator.

19. A non-transient computer-readable storage medium having instructions embodied thereon, the instructions being executable by one or more processors to perform a method for automatic generation of a post-meeting message, the method comprising:
obtaining, by an apparatus, meeting-based content associated with a meeting between a client and an advisor, the meeting-based content comprising a meeting transcript;
transmitting the meeting-based content comprising the meeting transcript to a conversational artificial intelligence (AI) tool with a prompt for generation of content for a draft post-meeting message;
obtaining, by the apparatus and from the conversational AI tool, a processed output of the conversational AI tool; and
dynamically generating, by the apparatus, the draft post-meting message based on the processed output of the conversational AI tool; and
providing the draft post-meeting message to an advisor computing device associated with the advisor for review or modification prior to sending to the client.

20. The computer-readable storage medium of claim 19, wherein the method further comprises:
transmitting, to the conversational AI tool, the prompt including post-meeting message data associated with desired characteristics of the post-meeting message.
